(19) United States
(12) Patent Application Publication
(10) Pub. No.: US 2004/0091337 A1
(43) Pub. Date: May 13, 2004

(54) Foup loading apparatus for foup opener

(75) Inventors: Wan Keun Lee, Seoul (KR); Yong Pyo Kim, Songnam-city (KR)

Correspondence Address: F. Chau & Associates, LLP, Suite 501, 1900 Hempstead Turnpike, East Meadow, NY, 11554, US

(73) Assignee: Shinsung Eng Corporation

(21) Appl. No.: 10/609,698

(22) Filed: Jun. 30, 2003

Related U.S. Application Data
(62) Division of application No. 09/939,963, filed on Aug. 27, 2001.

(30) Foreign Application Priority Data
Aug. 28, 2000 (KR) 2000-50159
Jul. 14, 2001 (KR) 2001-42556

(51) Int. Cl. B65G 1/00

(52) U.S. Cl. 414/217

(57) ABSTRACT

The present invention relates to a FOUP loading apparatus capable of implementing a stable horizontal and locking state when a FOUP is loaded and transferred by implementing a stable locking state of a locker on a stage of a FOUP opener and preventing ant interference when the FOUP is positioned. The FOUP loading apparatus for a FOUP opener includes a stage moved on a support base frame, a stage driving unit for forwardly and backwardly moving the stage along a set way, a locker locked on the stage for engaging the FOUP, and a locker driving unit for driving the locker. In the FOUP loading apparatus, a stable locking operation is implemented on a stage, and a stable positioning operation of the FOUP is obtained, so that it is possible to implement a stable FOUP positioning and loading operation from the positioning process to the transferring process.

### BACKGROUND OF THE INVENTION

1. Field of the Invention

The present invention relates to a FOUP loading apparatus for a FOUP opener(which is a kind of a wafer loading container for loading a large diameter wafer), and in particular to a FOUP loading apparatus for a FOUP opener which is capable of implementing a stable loading operation of a stage and a locker and an accurate horizontal state of a FOUP support base.

2. Description of the Background Art

Generally, a wafer is an important material for fabricating a semiconductor. Therefore, a wafer loading operation needs a certain cleanness and stability. When a wafer is loaded, the wafer is received in a FOUP and is loaded to a working place in a sealed state. The locked state of the FOUP is unlocked using a FOUP opener and is transferred to a working place(cleaned equipment). The conventional FOUP opener will be explained with reference to FIG. 1.

FIG. 1 is a perspective view illustrating the schematic structures of a conventional FOUP opener and FOUP.

As shown therein, a FOUP opener 100 is installed at an entrance of a clean room for a wafer process. A support base frame 120 is installed at the entrance in a horizontal direction, and a vertical frame 110 is formed thereat in a vertical direction. A door holder 130 is installed at the side of the vertical frame 110 of the FOUP opener, and the door holder 130 is installed in a frame 112 which is upwardly and downwardly moved in the back side of the vertical frame. The door holder 130 includes an adjusting pin 150 and a latch key 140 which are operable based on the opening state of the FOUP.

As shown in FIG. 1, the FOUP 200 engaged to the FOUP opener 100 is separated into a body and a door 210. An adjusting pin hole 230 and a latch key hole 220 are formed in the door 210. The door 210 is unlocked by the adjusting pin 150 and the latch key 140 of the door holder 130. The unlocked door 210 is moved to the back of the FOUP opener 100 by the door holder 130 for thereby opening the FOUP 200. The wafers are unloaded from the interior of the opened FOUP by a certain unloading member such as a robot arm, and the door 210 is returned to the original position by the door holder 130 and is locked. The locked FOUP 200, is moved to the original position by a certain transfer member.

The conventional FOUP opener has some problems when the FOUP is positioned on the stage.

First, the FOUP positioned on the stage is fixed by a locker or fixed on the stage when the stage movement is ended. There are various locking methods for fixing the FOUP on the stage. For example, a T-shaped section locker integrally installed on the stage and a 90° angled type locker installed on the support base frame, not on the stage, are known.

In the earlier case, the locker fixes the lower surface of the FOUP which is rotated on the stage at a certain angle and is placed, and in the later case, the FOUP is automatically engaged by the stage which is forwardly moved.

In the above-described locker type, it is impossible to separate the positioning FOUP in the upper direction but it is easier to separate by backwardly pulling the same. In addition, the FOUP is positioned by simply engaging the same, so that it is impossible to implement a stable engagement. The FOUP is downwardly moved by a transferring system capable of transferring the FOUP along a ceiling rail. In this case, if the positioning area is expanded, the FOUP may be collided with a protruded locker at the moment when the FOUP positioned.

Second, if the positioning of the FOUP is inaccurate, when the FOUP door is unlocked, a connection error occurs. Therefore, there is a big problem in that the process is continuously performed.

The positioning error may be detected by a certain detection unit. However, it is impossible to judge whether the positioned state is obtained in the horizontal state. It is possible to prevent a unloading error which occurs due to a difference with another apparatus which maintains an accurate horizontal in a process for opening a door of a FOUP or unloading the wafer from the opened FOUP by judging a horizontal state when the FOUP is positioned. In addition, it is possible to prevent a wafer damage which occurs when there is an unbalance with respect to the wafer by judging the horizontal state.

Therefore, when the FOUP is transferred through the automatic transfer system and is positioned on the support base frame, the locker must equip the following conditions.

When the locker is installed on the stage, the locker must be installed in a portion which is not higher than the height of a surface of the stage. The locking state on the lower surface of the FOUP must be stable. When the FOUP is positioned on the stage of the support base frame, the FOUP must be positioned on the stage without any collision, and an accurate horizontal state must be implemented.

### SUMMARY OF THE INVENTION

Accordingly, it is an object of the present invention to provide a FOUP loading apparatus for a FOUP opener which overcomes the problems encountered in the conventional art.

It is another object of the present invention to provide a FOUP loading apparatus for a FOUP opener which is capable of implementing a horizontal state of a stage by providing a horizontal state maintaining member and a support state that the FOUP is not separated upwardly or backwardly and is not movable.

In order to achieve the above objects, there is provided a FOUP loading apparatus for a FOUP opener which includes a stage moved on the support base frame, a driving unit for forwardly and backwardly moving the stage along a certain set way, and a locking unit installed in the stage for engaging the FOUP.

The locking unit further includes a driving unit which is independently operated on a lower surface of the stage and is formed of an upper engaging shoulder portion inserted under the lower surface of the FOUP, a shaft portion which forms a rotation center, and a lower operation bar moved by the driving unit.

In the FOUP loading apparatus according to the present invention, a lower driving plate is movably installed between the support base frame and the stage and is integrally connected with the stage. The stage is connected with the connection member in an opening of the support base frame. The connection member is connected with the lower driving plate. The lower driving plate is connected with a moving member which is moved along the fixing member fixed to a lower surface of the support base frame. The lower driving plate is movably connected with the front end of the rod of the driving unit. The stage includes more than one sensor for detecting the loading state of the FOUP on the stage, and a sensor for detecting whether the FOUP is loaded on the stage. A magnetic sensor is further provided for detecting the front and rear positions of the moved stage.

In another embodiment of the present invention, there is provided a FOUP loading apparatus for a FOUP opener which includes a support base frame having a concave portion, a support plate received in the concave portion of the support base frame and including a guide rail at upper both sides, a loading screw parallel with the guide rail and a stage driving motor for driving the loading screw, a stage including a guide member engaged with the guide rail of the support plate and a nut engaged with the loading screw on the lower surface of the same, and a locking unit including a locker inserted into a lower portion of the stage, protruded from the upper portion of the same and having a worm wheel in a lower portion for being fixed to the stage, a worm engaged with the worm wheel of the locker and a locker driving motor connected with the worm and generating a driving force. The stage includes more than one sensor for detecting the loading state of the FOUP on the stage, and a sensor for detecting whether the FOUP is loaded on the stage. In addition, there are further provided three pairs of fixing screws and level adjusting pins for maintaining a horizontal state of the stage of the FOUP loading apparatus according to the present invention.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a schematic structure of a conventional FOUP opener;

FIG. 2 is a disassembled view illustrating a support base frame of a FOUP loading apparatus of a FOUP opener and a stage according to the present invention;

FIG. 3 is a cross sectional view illustrating an engaged state of a support base frame of a FOUP loading apparatus and a stage according to the present invention;

FIG. 4 is an enlarged cross-sectional view illustrating a locker installation structure of a FOUP loading apparatus according to the present invention;

FIG. 5 is a bottom view illustrating a support base frame of a FOUP loading apparatus according to the present invention;

FIG. 6 is an enlarged cross-sectional view illustrating a horizontally engaged state of a stage and a lower driving plate of a FOUP loading apparatus according to the present invention;

FIG. 7 is a view illustrating a LM guide according to the present invention;

FIG. 8 is a plan view illustrating another embodiment of a FOUP loading apparatus according to the present invention;

FIG. 9 is a cross-sectional view illustrating another embodiment of a FOUP loading apparatus according to the present invention;

FIG. 10 is a cross-sectional view taken along line A-A of FIG. 8 according to the present invention;

FIG. 11 is a cross-sectional view taken along line B-B of FIG. 8 according to the present invention;

FIG. 12 is a cross-sectional view illustrating a locker which fixes a FOUP by cutting the same in a lateral direction in FIG. 8 according to the present invention; and

FIG. 13 is a cross-sectional view taken along line C-C of FIG. 12 according to the present invention.

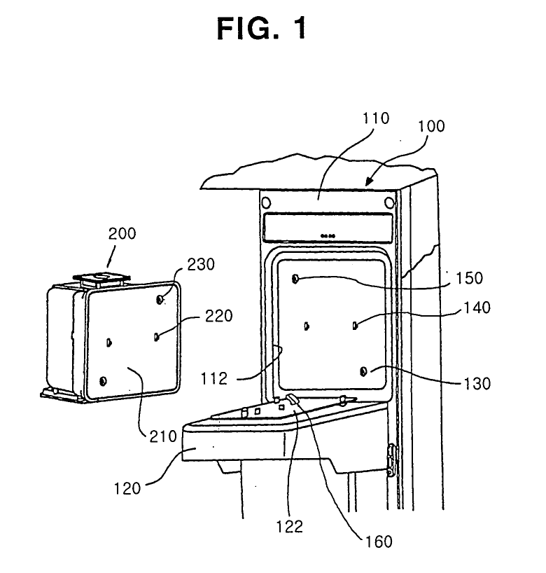

### DETAILED DESCRIPTION OF THE PREFERRED EMBODIMENTS

The present invention will be explained with reference to the accompanying drawings.

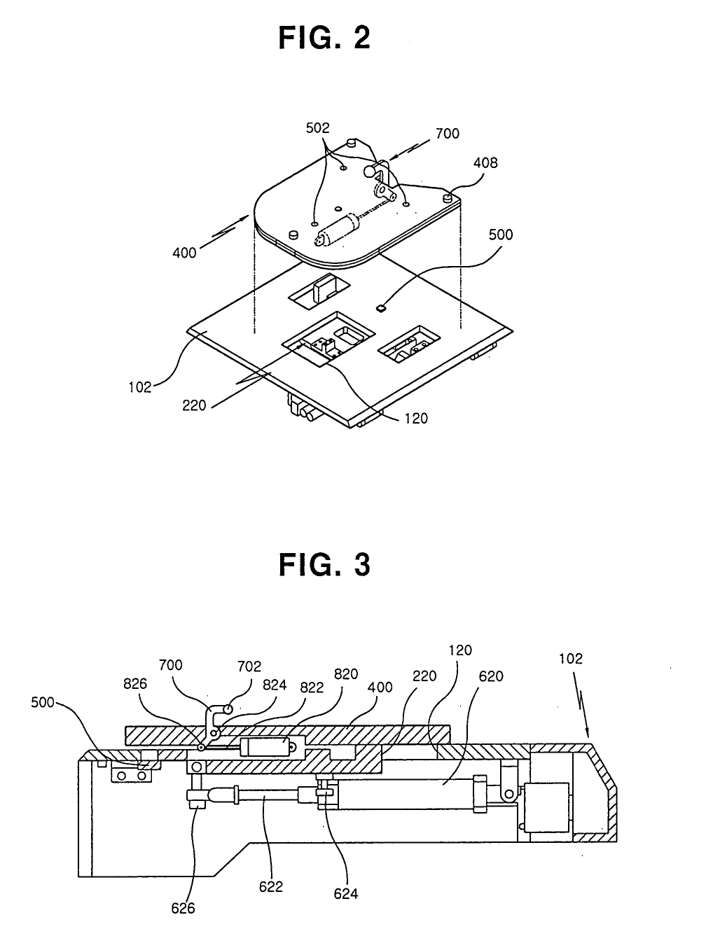

FIGS. 2 through 7 are view illustrating a FOUP loading apparatus of a FOUP opener according to the present invention which uses a pneumatic cylinder as a driving unit of a stage and a locker.

FIG. 2 is a disassembled perspective view of a support base frame and a stage of a FOUP loading apparatus of a FOUP opener according to the present invention. As shown therein, the support base frame 102 capable of moving the stage 400 thereon is separated. A lower driving plate 220 is positioned on the lower surface of the support base frame 102, and the lower driving plate 220 is integrally connected with the stage 400 through an opening 120.

As shown in FIG. 2, the stage 400 is fabricated in a certain shape plate member, and a concave portion is formed in the center of the end portion of the stage 400, and a locker 700 is installed in the concave portion. The locker 700 will be explained later.

On the upper portion of the stage, there are three positioning pins 408, and a FOUP loading state detection sensor 500 for detecting a loading state of the FOUP, and normal position sensors 502 for detecting the FOUP positioning state.

FIG. 3 is a cross-sectional view illustrating an engaging state of the support base frame and stage of the FOUP loading apparatus according to the present invention.

The stage driving unit 620 according to the present invention is installed at a portion distanced from the lower driving plate 220 on the lower surface of the support base frame 102. The stage driving unit 620 is formed of a pneumatic cylinder and includes a rod 622 which is moved through the front portion. The front end of the rod 622 is connected with the lower driving plate 220 for thereby moving the lower driving plate 220 using the stage driving unit 620. The front end of the rod 622 is connected with the lower driving plate 220 using a bolt 626.

In the stage, a support base frame 102 is positioned in the lower portion, and the lower driving plate 220 is movably positioned at the side of the opening of the support base frame 102.

Since the lower driving plate 220 is connected with the stage 400 on the support base frame 102 through the opening 120 formed in the support base frame 102, the stage 400 is positioned above the support base frame 102 by the lower driving plate 220. Therefore, when the lower driving plate 220 is moved by the stage driving unit 620, the stage 400 is moved.

The locker 700 is positioned in the front surface of the stage 400. The locker 700 is rotatably installed in an end groove portion of the stage 400. The movement distance of the stage 400 is detected by a magnetic sensor 624 attached in the stage driving unit 620.

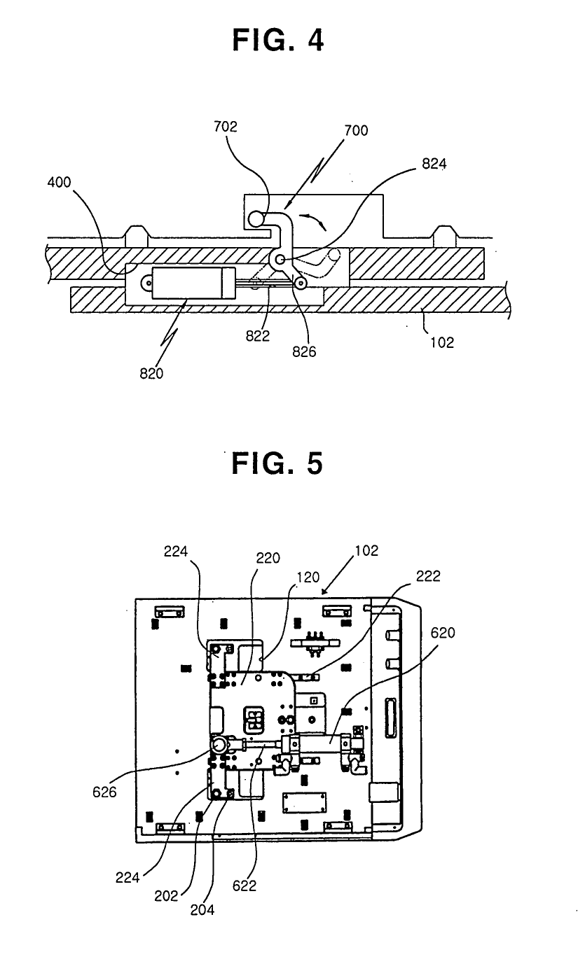

FIG. 4 is an enlarged cross-sectional view illustrating a locker installation structure of the FOUP loading apparatus according to the present invention.

The locker 700 capable of maintaining a horizontal state of the FOUP on the stage 400 is rotatably installed in a portion of the groove of the stage 400. The locker 700 includes an angled upper engaging shoulder portion 702 inserted into the lower surface of the FOUP, a shaft 824 which forms a rotation center, and a slanted lower operation bar 826 moved by the driving unit.

The operation bar 826 is connected with a rod 822 of the locker driving unit 820 which is independently operated on the lower surface of the stage 400. The locker driving unit 820 is a pneumatic cylinder having a fixed end portion and connects the front end of the rod 822 with the operation bar 826 of the locker.

Therefore, the locker 700 is rotated based on a pneumatic operation of the locker driving unit 820 and is inserted into the lower portion of the stage and engages the lower surface of the FOUP. The front end of the engaging shoulder portion 702 is formed in a flexible slidable sphere shape.

FIG. 5 is a bottom view illustrating the support base frame of the FOUP loading apparatus according to the present invention.

FIG. 5 illustrates the installation structures of the stage driving unit 620 on the lower surface of the support base frame 102 which forms the opening 120.

A hole is formed on the front end of the rod 622 of the stage driving unit 620 for passing through the bolt 626.

The lower driving plate 220 includes a connection member on the upper surface and includes three pairs of level adjusting pins 202 and fixing screws 204 for maintaining a horizontal state of the stage. The horizontal state implemented using the level adjusting pins 202 and the fixing screws 204 will be explained later.

Two portions of the stage 400 and the lower driving plate 220 are connected using the connection member 224, and the remaining one portion is connected with the level adjusting pins 202 and the fixing screws 204 from the lower driving plate 220 and the stage 400 through the opening 120. The level adjusting pins 202 and the fixing screws 204 are connected with the connection member.

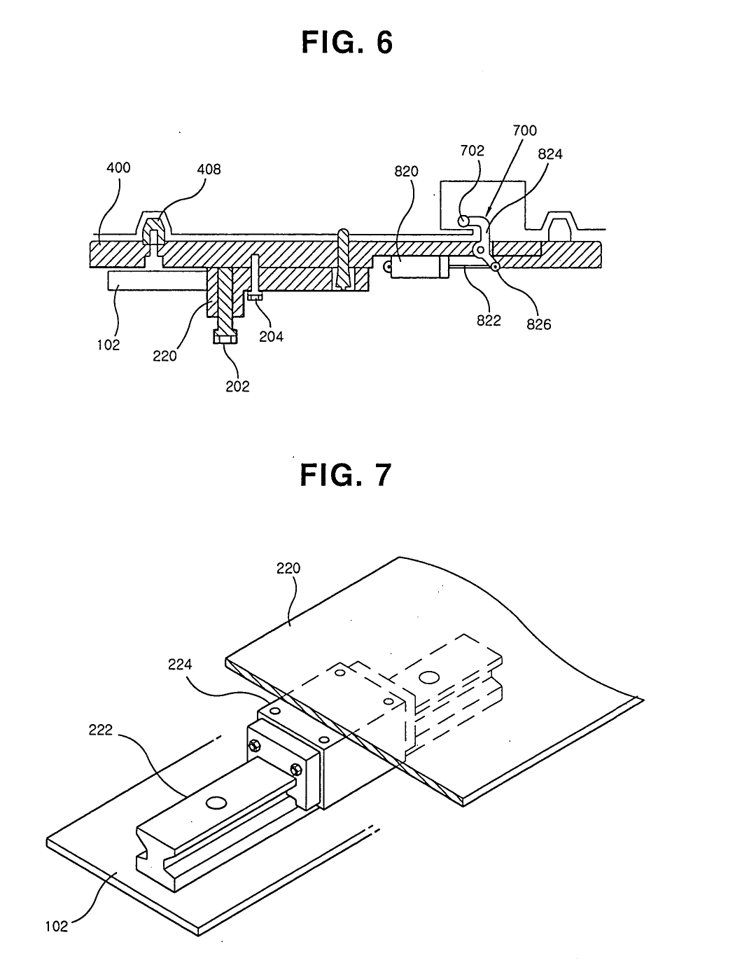

FIG. 6 is an enlarged cross-sectional view illustrating a horizontal engaged relationship of the stage and lower driving plate of the FOUP loading apparatus according to the present invention.

A pair of the level adjusting pin 202 and the fixing screw 204 are installed for maintaining a horizontal state of the stage 400 connected with the lower driving plate 220 which is moved in the lower portion of the support base frame 102. Namely, the, horizontal state of the stage 400 is roughly adjusted using the level adjusting pin 202, and the fixing screw 204 is sequentially fixed for thereby implementing a horizontal state of the stage.

FIG. 7 is a view illustrating the LM guide according to the present invention.

The LM guide is formed of a fixing member 222 and a moving member 224. The fixing member 222 is fixed on the upper surface of the support base frame 102, and the moving member 224 is attached to the lower surface of the lower driving plate 220. The moving member 224 is formed of a plurality of ball bearings.

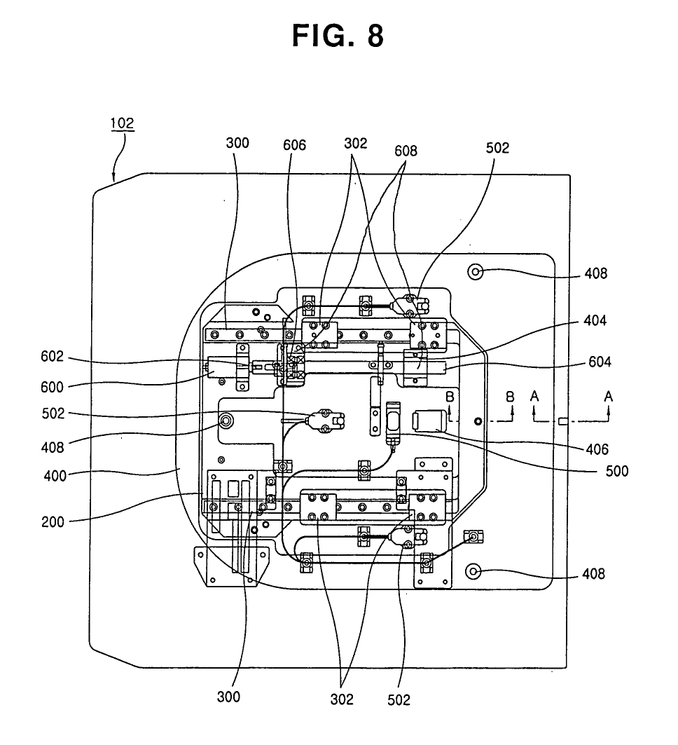

FIGS. 8 through 13 are views of another embodiment of the FOUP loading apparatus of the FOUP opener according to the present invention which uses driving motors as a driving unit of the stage and the locker.

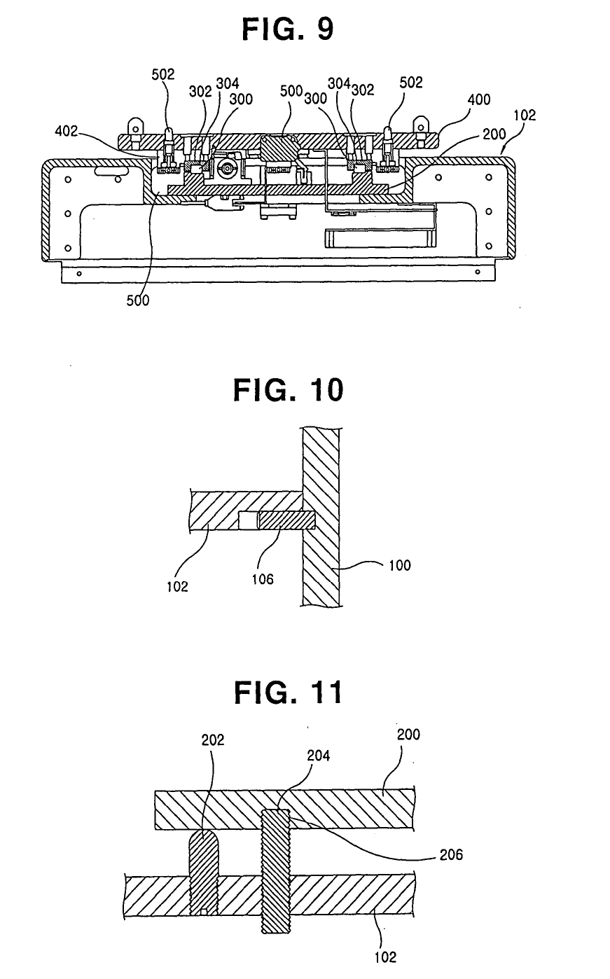

FIGS. 8 and 9 are plan and cross-sectional views of another embodiment of the FOUP loading apparatus of the FOUP opener according to the present invention.

As shown therein, the center portion of the support base frame 102 is grooved, and the support plate 200 is inserted into the groove. The height of the support plate 200 is adjustable. The above-described construction will be explained with reference to FIGS. 10 and 11. A guide rail 300 is installed at both sides of the support plate 200. A guide member 302 is installed at both sides of the stage 400, so that the stage is moved along the guide rail 300. The guide member 302 includes an inverted U-shaped positioning groove 304 positioned in the guide rail 300 and is fixed to the stage 400 based on a fixing bracket 402. Normal position detection sensors 502 are installed in both front sides and rear center portion of the stage distanced from the guide member 302 by a certain distance for detecting whether the FOUP is accurately positioned. A loading state detection sensor 500 is installed in the center portion of the stage for detecting whether the FOUP is loaded.

A stage driving motor 600 is fixed to an upper portion of the support plate 200, and a loading screw 604 is coupled to the shaft 602 of the stage driving motor 600. The loading screw 604 is installed parallely with respect to the guide rail 300, and one end of the same is fixed to the support plate 200 using a loading screw support bracket 608 based on the bearing 606 for implementing a smooth movement. A nut 404 is engaged with the lower portion of the stage 400. Therefore, the nut 404 is linearly moved based on the rotation of the loading screw 604 and linearly moves the stage 400 fixed to the nut 404. The moving direction of the nut 404 is changed based on the change of the rotation direction of the loading screw 604, so that the stage 400 is reciprocated.

FIG. 10 is a cross-sectional view taken along line A-A of FIG. 8 for explaining a centering method of the support plate, and FIG. 11 is a cross-sectional view taken along line B-B for explaining the height adjusting unit of the stage.

As shown in FIG. 10, the support base frame 102 is fixed to the main frame 100. The centering operation is implemented using the center adjusting pin 106. In order to adjust the level of the stage 400, the level adjusting pin 202 is vertically engaged to the lower plate portion of the groove of the support base frame 102 for adjusting the level of the stage 400 as shown in FIG. 11, so that the support plate 200 is supported by the end portion of the same. The level adjusting pin 202 is rotated below the support base frame 102 for thereby adjusting the height of the same, and the fixing screw 204 is engaged into the screw hole 206 of the support plate 200 for thereby fixing the adjusted height. Three level adjusting pins 202 are installed. Namely, as shown in FIG. 8, one is installed in the front portion of the stage 400, and the remaining two are installed in rear portions. The horizontal height of the stage is adjusted by adjusting the level adjusting pin of the front portion. Therefore, it is possible to easily arrange the heights of the latch key hole of the FOUP and the latch key of the door holder by adjusting only one level adjusting pin positioned in the front portion. After the level of the front portion of the FOUP is adjusted, the horizontal height of the FOUP is adjusted by adjusting two level adjusting pins in the rear portion.

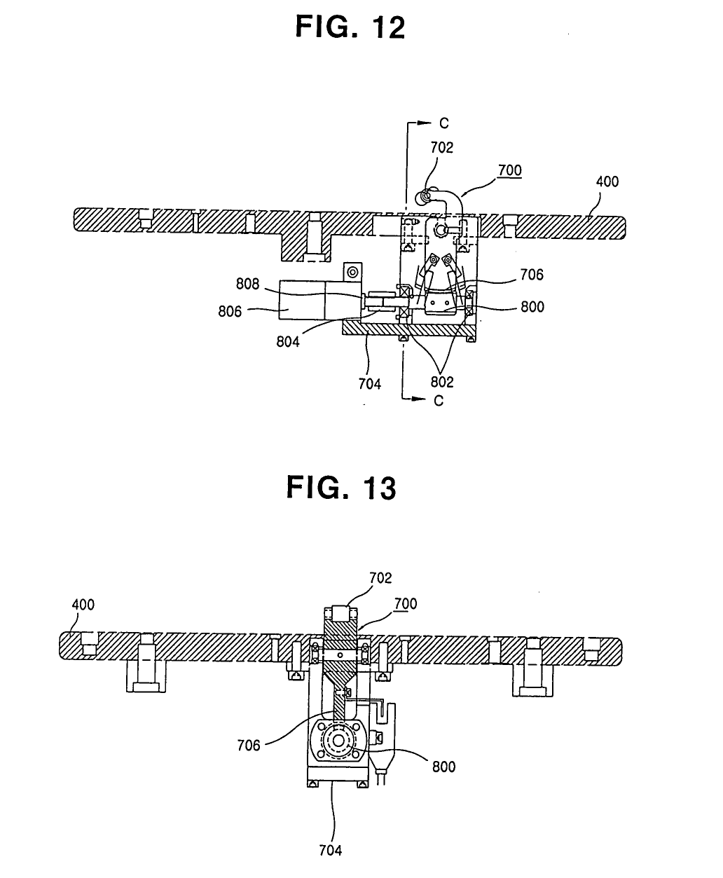

FIG. 12 is a cross-sectional view obtained by cutting a lateral side of the locker portion which fixes the FOUP of FIG. 8, and FIG. 13 is a cross-sectional view taken along line C-C of FIG. 12.

The locker 700 is fixed to a lower portion of the stage 400, and the upper portion of the same is exposed to the locker unloading port of the stage 400. The upper engaging portion 702 of the locker 700 is inserted into a locking hole of the lower surface of the FOUP(not shown) for thereby fixing the FOUP on the stage 400. The locker 700 is fixed to a lower portion of the stage 400 using the locker bracket 704, and a worm wheel 706 is formed in a lower portion of the body of the locker 700. The worm wheel 706 is engaged with a worm 800 positioned in the lower portion. The worm 800 is supported by the bearings 802 fixed to the locker bracket 704, and one end of the same is connected with the shaft 808 of the locker driving motor 806. Therefore, when the locker driving motor 806 is rotated, the work 800 is rotated by receiving the driving force of the locker driving motor 806, and as the worm 800 is rotated, the worm wheel 706 connected with the worm 800 is rotated, and the locker 700 is rotated at a certain rotation angle. The engaging shoulder portion 702 of the upper portion of the same is rotated in the forward direction about the shaft in the locker 700 and is inserted into the locking hole of the FOUP for thereby fixing the FOUP on the stage 400. The apparatus according to the present invention is implemented by the worm 800 rotated by the locker driving motor 806 as a driving force source of the locker 700 and a worn wheel 706 which is rotated based on an engagement with the worm 800.

The operation of the present invention will be explained with reference to the accompanying drawings.

In the present invention, when a worker places a FOUP on the stage, the operation is started. When the FOUP is placed on the upper surface of the stage, the position of the FOUP is determined based on three positioning pins. Thereafter, the FOUP loading state detection sensor detects the loading state of the FOUP, and the normal position detection sensors detect whether the FOUP is normally positioned and compares with a reference value. If unbalanced, a certain operation mode is stopped or an alarming signal is outputted.

When the FOUP is normally positioned, the rod of the locker driving unit moves the locker lower operation bar, and the locker having the moved lower portion is rotated with respect to the shaft portion and engages a certain portion of the lower surface of the FOUP on which the upper engaging shoulder portion is positioned. The FOUP positioned on the stage is stably engaged by the locker for thereby maintaining a positioned state.

The stage is forwardly moved by a certain distance by driving the stage driving unit. The FOUP positioned on the stage based on the movement of the stage is moved to the side of the door holder of the FOUP opener, and the movement of the stage is stopped by the magnetic sensor attached to the driving unit, and the door opening operation of the FOUP is performed.

In the present invention, the problems that the stage is fixed by only the fixing screws are overcome using a pair of fixing units formed of level adjusting pins and fixing screws capable of adjusting the horizontal state of the stage.

In addition, the horizontal state of the stage and the support base frame is implemented, and in a state that the FOUP is positioned, the horizontal state is detected for thereby readjusting the level of the stage for thereby preventing a damage of the wafer when unloading the same.

In particular, an engaging shoulder portion of the rotation engagement is implemented so that the FOUP on the stage is not moved in the upper or rear ward direction for thereby implementing a stable support state.

In the FOUP loading apparatus of the FOUP opener, even when the locker is installed on the stage, it is installed at a height lower than the stage, and since the positioning area of the FOUP is wide on the stage of the support base frame, it is possible to prevent any interference of the FOUP due to a locker.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a FOUP loading apparatus of a FOUP opener in which a FOUP is loaded on a support base frame fixed to a main frame and is moved to a door opening apparatus, a FOUP loading apparatus of a FOUP opener, comprising:
a support base frame having a certain opening;
a lower driving plate which is movable in a front and rear direction in a lower portion of the support base frame and integrally connected with a stage through the opening;
a stage which is connected with the lower driving plate and is movable in a front and rear direction;
a stage driving means formed of a pneumatic cylinder fixed to a lower portion of the support base frame and a rod for forwardly and backwardly moving the stage;
a locker rotatably installed in a front surface groove of the stage for fixing by engaging a lower surface of the FOUP on the stage; and
a locker driving means formed of a pneumatic cylinder and rod for driving the locker.

2. The apparatus of claim 1, wherein said locker includes a certain shaped engaging shoulder portion for fixing the FOUP on the lower surface of the FOUP, a shaft portion which forms a rotation center, and an operation bar which received a certain driving force in a lower portion.

3. The apparatus of claim 1, wherein said lower driving plate is mounted in the support base frame through a LM guide.

4. The apparatus of claim 3, wherein said LM guide includes a fixing member fixed on a lower surface of the support base frame, and a moving member slidably engaged to the fixing member.

5. The apparatus of claim 1, further comprising:
three normal position detection sensors installed in front both sides and a rear center portion on the stage, and a loading state detection sensor installed on a center portion of the stage.

6. The apparatus of claim 1, further comprising:
a center adjusting pin inserted in the support base frame and the main frame for arranging the center of the same and grounding the same.

7. The apparatus of claim 1, wherein said driving means includes a magnetic sensor for detecting a front and rear position of the stage.

8. The apparatus of claim 1, further comprising:
a level adjusting pin installed between the stage and the lower driving plate for adjusting a horizontal state of the stage, and a fixing screw for fixing the stage to the lower driving plate.

9. In a FOUP loading apparatus of a FOUP opener in which a FOUP is loaded on a support base frame fixed to a main frame and is moved to a door opening apparatus, a FOUP loading apparatus of a FOUP opener, comprising:
a support base frame having a concave portion;
a support plate received in the concave portion of the support base frame and including a guide rail at upper both sides, a loading screw parallel with the guide rail and a stage driving motor for driving the loading screw;
a stage including a guide member engaged with the guide rail of the support plate and a nut engaged with the loading screw on the lower surface of the same; and
a locking means including a locker inserted into a lower portion of the stage, protruded from the upper portion of the same and having a worm wheel in a lower portion for being fixed to the stage, a worm engaged with the worm wheel of the locker and a locker driving motor connected with the worm and generating a driving force.

10. The apparatus of claim 9, further comprising:
a level adjusting pin installed between the support base frame and the support plate for adjusting a horizontal state of the stage connected with the support plate, and a fixing screw for fixing the support plate near the level adjusting pin to the support base frame.

11. The apparatus of claim 10, wherein a pair of said level adjusting pin and fixing screw are installed in a front portion of the stage, and two pairs of the same are installed in the rear portion of the stage.

12. The apparatus of claim 9, wherein said locker driving motor and worm are coupled by a coupler, and the locker driving motor is fixed to a lower surface of the stage, and both ends of the worm are rotatably supported on the locker bracket.

13. The apparatus of claim 9, wherein said guide member positioned on and guided by the guide rail is positioned on the guide rail having an inverted U-shaped positioning groove in the lower surface.

14. The apparatus of claim 9, further comprising:
a center adjusting pin inserted into the support base frame and the main frame and arranging the centers of the same.

15. The apparatus of claim 9, further comprising:
three normal position detection sensors installed in front both sides and a rear center portion of the stage, and a loading state detection sensor installed in a center portion of the stage.
